(19) United States
(12) Patent Application Publication
(10) Pub. No.: US 2026/0056884 A1
(43) Pub. Date: Feb. 26, 2026

(54) STORAGE SYSTEM AND REMOTE COPY METHOD

(71) Applicant: Hitachi Vantara, Ltd., Yokohama-shi (JP)

(72) Inventors: Takaki MATSUSHITA, Tokyo (JP); Akira DEGUCHI, Tokyo (JP)

(21) Appl. No.: 19/080,059

(22) Filed: Mar. 14, 2025

(30) Foreign Application Priority Data
Aug. 22, 2024 (JP) 2024-141011

(51) Int. Cl. G06F 12/0802

(52) U.S. Cl. CPC G06F 12/0802

(57) ABSTRACT

In a secondary storage system, a processor of the secondary storage system receives a journal including journal data that is write target data for a primary volume from a primary storage system and metadata, associates a logical address of a secondary journal volume that manages the journal data included in the journal with a predetermined area of a pool in the secondary storage system, and associates an address of the predetermined area associated with the journal data of the pool with a logical address of a secondary volume in which the write target data indicated by the metadata included in the journal is stored.

### CROSS-REFERENCE TO RELATED APPLICATION

The present application claims priority from Japanese application JP2024-141011, filed on Aug. 22, 2024, the content of which is hereby incorporated by reference into this application.

### BACKGROUND OF THE INVENTION

### 1. Field of the Invention

The present invention relates to remote copy of data from one storage system to another storage system.

### 2. Description of Related Art

A technique related to remote copy of data from a primary storage system to a secondary storage system is known for the purpose of disaster recovery (DR) or the like. In addition, in order to reduce an amount of data loss when a disaster occurs, that is, to shorten a recovery point objective (RPO), a journal type remote copy technique is known.

For example, PTL 1 discloses a remote copy technique in which write target data from a host to a primary volume (PVOL) of a primary storage system and information on a write order and a write position are stored in a journal volume (JVOL), journal data (write target data) stored in the JVOL and information on the write order and the write position are transmitted from the primary storage system to a secondary storage system in response to a request from the secondary storage system, the journal data and the information on the write order and the write position are stored in the JVOL when the journal data and the information on the write order and the write position are received in the secondary storage system, and the journal data is written (restored) to a secondary volume (SVOL) according to the information on the write order and the write position.

### CITATION LIST

### Patent Literature

PTL 1: U.S. Pat. No. 7,152,079

### SUMMARY OF THE INVENTION

There may be a remote copy configuration in which data is copied from an on-premise primary storage system to a secondary storage system implemented by a public cloud such as a software defined storage (SDS). Cost optimization is one of the purposes of using a storage system generally implemented by a public cloud. Resources (memory capacity, back end bandwidth, and the like) of a public cloud compute instance that runs storage software such as SDS are often poorer than those of a primary storage system implemented by on-premise dedicated hardware. In the case of a configuration in which resources are unbalanced between primary and secondary sides of the remote copy, the remote copy technique disclosed in PTL 1 may cause problems related to copy performance and capacity.

That is, since the write target data received by the primary storage system is written to the PVOL and the JVOL, a cache memory is consumed twice with the same data. Similarly, when the journal data received by the secondary storage system is restored from the JVOL to the SVOL, copy processing is required on the cache memory, and a cache memory capacity of the same data is consumed twice by the JVOL and the SVOL. In particular, when the memory capacity is small as in the SDS of the public cloud, a ratio of dirty data (data in the cache memory that is not written to a drive) in the cache memory capacity increases, making it easier for journal data to be destaged to the drive. Further, when the data is evicted from the cache memory after being destaged and becoming clean data (data in the cache memory that is written to the drive), the journal data is to be staged again from the drive when it is restored to the SVOL.

As described above, copy performance from the primary storage system to the secondary storage system cannot be increased more than a write load from the host to the primary storage system, and the journal data stays in the JVOL of the primary storage system or the secondary storage system. As a result, RPO deteriorates. When the journal data stays in excess of the capacity of the JVOL, a remote copy state is stopped or an inflow (writing) of the write data from the host is restricted, which causes a deterioration in host IO performance. When the primary storage system or the secondary storage system is an SDS of a public cloud having a small cache memory capacity, the journal data is easily destaged, and a temporary storage area for storing the journal data is always required. Further, when the secondary storage system has a volume of another task that does not implement the remote copy, task performance is likely to be affected by the presence of a remote copy volume that consumes a large amount of cache memory.

It is required to improve the RPO even in a configuration in which resources are not unbalanced between the primary storage system and the secondary storage system.

The invention has been made in view of the above circumstances, and an object thereof is to provide a technique capable of improving copy performance in remote copy of data from one storage system to another storage system.

In order to achieve the above object, a storage system according to one aspect is a storage system having a secondary volume that is a copy destination of a primary volume in another storage system having the primary volume. A processor of the storage system receives a journal including journal data that is write target data for the primary volume from the another storage system and metadata for the journal data, associates a logical address of a secondary journal volume that manages the journal data included in the journal with a predetermined area of a capacity pool in the storage system, and associates an address of the predetermined area associated with the journal data of the capacity pool with a logical address of the secondary volume in which the write target data indicated by the metadata included in the journal is stored.

According to the invention, copy performance can be improved in remote copy of data from one storage system to another storage system.

### BRIEF DESCRIPTION OF THE DRAWINGS

FIG. 1 is an overall configuration diagram of a remote copy system according to an embodiment;

FIG. 2 is a configuration diagram of a storage system and a maintenance terminal according to an embodiment;

FIG. 3 is a diagram showing an outline of remote copy according to an embodiment;

FIG. 4 is a configuration diagram of a memory of the storage system according to an embodiment;

FIG. 5 is a configuration diagram showing an SEQ # table according to an embodiment;

FIG. 6 is a configuration diagram of a JNCB according to an embodiment;

FIG. 7 is a configuration diagram of a volume mapping table according to an embodiment;

FIG. 8 is a configuration diagram of a pool mapping table according to an embodiment;

FIG. 9 is a flowchart showing write processing according to an embodiment;

FIG. 10 is a flowchart showing JNL transfer processing according to an embodiment;

FIG. 11 is a flowchart showing restoration processing according to an embodiment; and

FIG. 12 is a flowchart showing read processing according to an embodiment.

### DESCRIPTION OF EMBODIMENTS

An embodiment will be described with reference to the drawings. The embodiment to be described later does not limit the invention according to the claims, and all of the various elements described in the embodiment and the combinations thereof are not necessarily essential for the solution of the invention.

In the following description, an “interface device” may be one or more interface devices. The one or more interface devices may be at least one of the following.
One or more input/output (I/O) interface devices. The input/output (I/O) interface device is an interface device for at least one of an I/O device and a remote display computer. The I/O interface device for the display computer may be a communication interface device. The at least one I/O device may be a user interface device, for example, an input device such as a keyboard and a pointing device, or an output device such as a display device.
One or more communication interface devices. The one or more communication interface devices may be one or more communication interface devices of the same type (for example, one or more network interface cards (NICs)) or two or more communication interface devices of different types (for example, an NIC and a host bus adapter (HBA)).

In the following description, a “memory” is one or more memory devices, which are examples of one or more storage devices, and may be typically a main storage device. At least one memory device in the memory may be a volatile memory device or a non-volatile memory device.

In the following description, a “persistent storage device” may be one or more persistent storage devices, which are examples of one or more storage devices. The persistent storage device may be typically a non-volatile storage device (for example, an auxiliary storage device), and specifically may be, for example, a hard disk drive (HDD), a solid state drive (SSD), a non-volatile memory express (NVME) drive, or a storage class memory (SCM).

In the following description, the “storage device” may be at least the memory in the memory and the persistent storage device.

In the following description, a “processor” may be one or more processor devices. At least one processor device may typically be a micro-processor device such as a central processing unit (CPU), but may also be another type of processor device such as a graphics processing unit (GPU). At least one processor device may be single-core or multi-core. At least one processor device may be a processor core. At least one processor device may be a processor device in a broad sense, such as a circuit (for example, a field-programmable gate array (FPGA), a complex programmable logic device (CPLD), or an application specific integrated circuit (ASIC)), which is an aggregate of gate arrays in a hardware description language in which a part or all of processing is executed.

In the following description, information that can be output in response to an input may be described by an expression such as “AAA table”, whereas the information may be data of any structure (for example, may be structured data or unstructured data), and may be a learning model such as a neural network, a genetic algorithm, or a random forest that generates an output in response to an input. Therefore, the “AAA table” can be referred to as “AAA information”. In the following description, a configuration of each table is an example. One table may be divided into two or more tables, or all or some of two or more tables may be one table.

In the following description, processing may be described using a “program” as a subject, but since a program is executed by a processor to perform predetermined processing using a storage device and/or an interface device as appropriate, the subject of the processing may be a processor (or a device or a system including the processor). The program may be installed on a device such as a computer from a program source. The program source may be, for example, a program distribution server or a computer-readable recording medium (for example, a non-transitory recording medium). In the following description, two or more programs may be implemented as one program, or one program may be implemented as two or more programs.

A “volume” (VOL) is a logical storage area. The volume may be a substantive volume (RVOL) or a virtual volume (VVOL). The “RVOL” may be a VOL based on a storage device, and the “VVOL” may be a volume according to a capacity virtualization technique (typically, thin provisioning).

The “storage system” may be a system including a plurality of storage devices and a controller that performs I/O of data with respect to the plurality of storage devices, or may be a system including one or more physical computers. In the latter system, for example, each of one or more physical computers may execute predetermined software to construct the one or more physical computers as software-defined anything (SDx). As the SDx, for example, a software-defined storage (SDS) or a software-defined datacenter (SDDC) can be adopted.

In addition, in the following description, when elements of the same type are described without being distinguished, a common reference numeral may be used, and when elements of the same type are distinguished and described, reference numerals may be used.

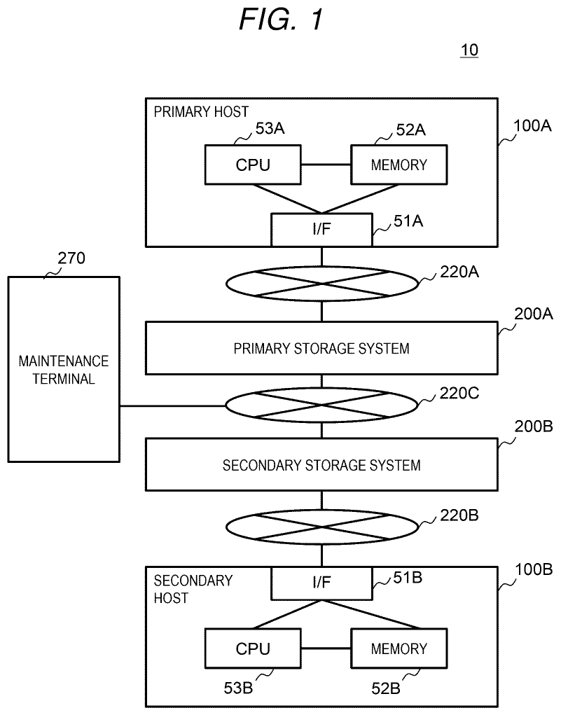

FIG. 1 is an overall configuration diagram of a remote copy system according to an embodiment.

A remote copy system 10 includes a primary host 100A, a primary storage system 200A, a secondary host 100B, a secondary storage system 200B, and a maintenance terminal 270.

The primary host 100A is connected to the primary storage system 200A via a network 220A (for example, a front end network). The secondary host 100B is connected to the secondary storage system 200B via a network 220B (for example, a front end network). The primary storage system 200A and the secondary storage system 200B are connected via a network 220C (for example, a back end network). Two or more networks of the networks 220A to 220C may be common, or at least one of the networks 220A to 220C may be a dedicated line.

A site (primary site) including the primary host 100A and the primary storage system 200A and a site (secondary site) including the secondary host 100B and the secondary storage system 200B may be geographically separated.

The primary host 100A is a computer having an interface device 51A, a memory 52A, and a CPU 53A. The secondary host 100B is a computer having an interface device 51B, a memory 52B, and a CPU 53B. At least one of the primary host 100A and the secondary host 100B may be a virtual device (for example, a virtual machine (VM) or a container). The primary host 100A may be a virtual device and provided in the primary storage system 200A, and similarly, the secondary host 100B may be a virtual device and provided in the secondary storage system 200B. That is, at least one of the storage systems 200A and 200B may be a so-called hyper-converged storage system.

The secondary host 100B may be omitted. For example, when a distance between the storage systems 200A and 200B is short, the primary host 100A may be connected to the secondary storage system 200B in addition to the primary storage system 200A. The secondary host 100B may be connected to the primary storage system 200A in addition to the secondary storage system 200B. Either or both of the storage systems 200 (200A, 200B) may be systems installed in a collocation, or may be systems on a cloud that provides a cloud computing service (storage service). For example, the primary storage system 200A may be an on-premise storage system, and the secondary storage system 200B may be a public cloud storage system that has fewer resources than an on-premise system. Conversely, the primary storage system 200A may be a public cloud storage system, and the secondary storage system 200B may be an on-premise storage system that has more resources than the public cloud.

The primary host 100A executes software (for example, a database management system (DBMS)) that executes task processing, and transmits a data write request to the primary storage system 200A. The primary storage system 200A stores data according to the write request. Remote copy is performed between the storage systems 200A and 200B. That is, the secondary storage system 200B receives data from the primary storage system 200A and stores the received data.

When a failure occurs in the primary host 100A or the primary storage system 200A, disaster recovery is performed. When the disaster recovery is performed, the secondary host 100B can continue the task processing of the primary host 100A using the data in the secondary storage system 200B.

The maintenance terminal 270 is connected to the network 220C. The maintenance terminal 270 communicates with at least one of the storage systems 200A and 200B for maintenance or management of the storage system 200. The maintenance terminal 270 may be connected to the network 220A to maintain the primary storage system 200A. Another maintenance terminal 270 may be connected to the network 220B to maintain the storage system 200B.

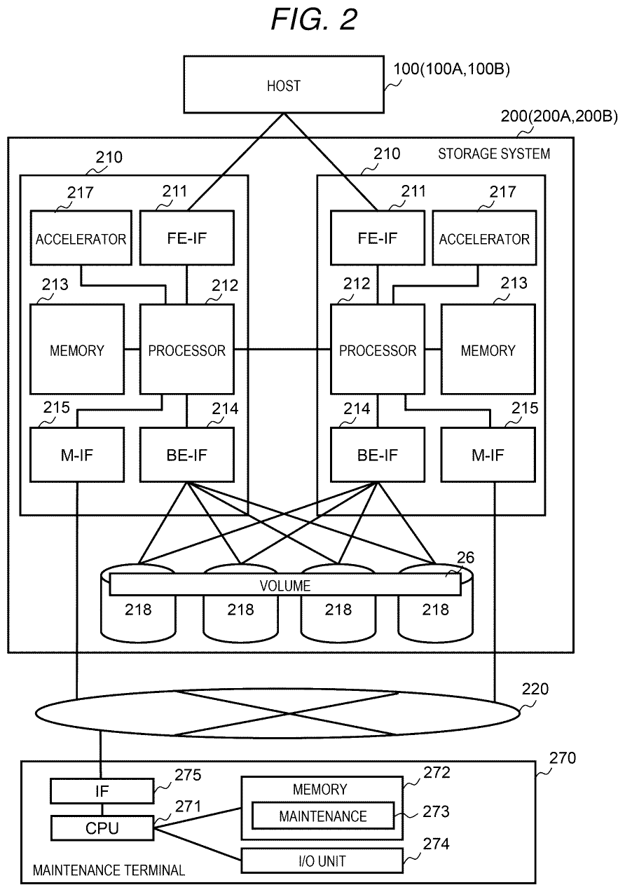

FIG. 2 is a configuration diagram of the storage system and the maintenance terminal according to an embodiment.

The storage system 200 (200A, 200B) includes a drive group (a plurality of drives 218) and redundant controllers 210 (two in FIG. 2) that perform I/O of data with respect to the drive group. The drive 218 is an example of a persistent storage device. The drive group may constitute one or more redundant array of independent (or inexpensive) disks (RAID) groups. A volume 26 is provided based on the drive group.

The controller 210 includes a front end interface (FE-IF) 211, a back end interface (BE-IF) 214, a management interface (M-IF) 215, an accelerator 217, a memory 213, and a processor 212 connected thereto.

The FE-IF 211 is an interface device that communicates with the host 100. The FE-IF 211 may have a plurality of ports (for example, a Fibre Channel port, and an iSCSI port). A path of the remote copy (a path through which data to be transferred passes) may be a path including a port of the FE-IF 211 of the primary storage system 200A and a port of the FE-IF 211 of the secondary storage system 200B. The controller 210 may include an interface device for remote copy separately from the FE-IF 211.

The BE-IF 214 is an interface device that communicates with each drive 218. The M-IF 215 is an interface device that communicates with the maintenance terminal 270. The port of the M-IF 215 may be included in the path of the remote copy instead of the port of the FE-IF 211.

The memory 213 stores programs and data. The memory 213 may include, for example, a cache memory area for temporarily storing data.

The processor 212 executes various kinds of processing by executing the program stored in the memory 213.

The accelerator 217 is a hardware circuit (for example, an FPGA or an ASIC) that executes a part of processing of the processor 212 (for example, compression or decompression of data). The accelerator 217 may be a part of a processor in a broad sense including the processor 212. The accelerator 217 may not be provided.

The maintenance terminal 270 is a computer including an IF 275, an I/O unit 274, a memory 272, and a CPU 271 connected thereto. The IF 275 is an interface device having a port connected to the network 220. The I/O unit 274 is a user interface device such as a keyboard, a pointing device, and a display device. The memory 272 stores a program (for example, the maintenance program 273) and data. The CPU 271 performs processing related to the maintenance of the storage system 200 by executing the maintenance program 273. For example, by executing the maintenance program 273, the CPU 271 may receive information (for example, a remote copy pair creation request between the storage systems 200A and 200B) from a user via the I/O unit 274, set the received information in the storage system 200 via the IF 275, and request processing.

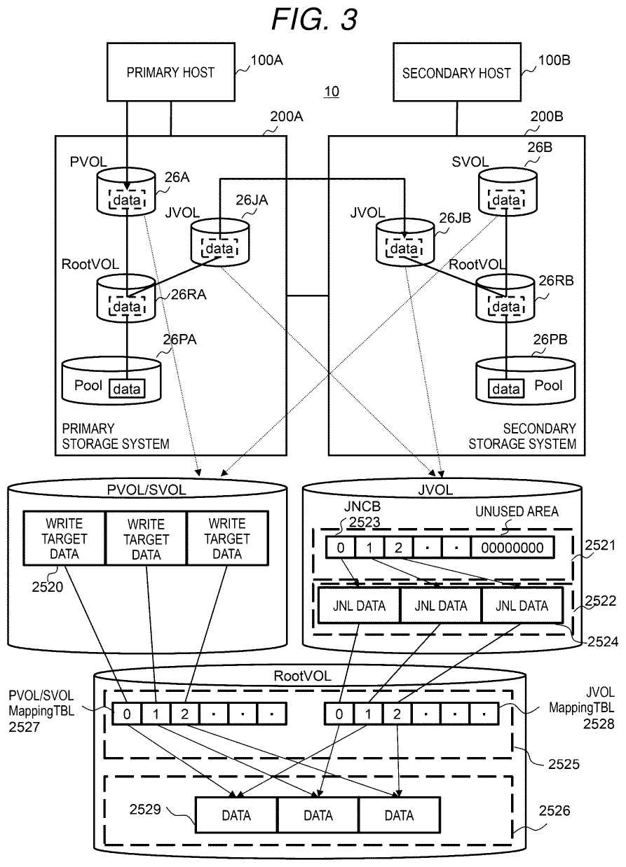

FIG. 3 is a diagram showing an outline of the remote copy according to an embodiment. FIG. 3 shows the outline of the remote copy from the primary storage system 200A to the secondary storage system 200B.

The remote copy according to the present embodiment is performed asynchronously with processing according to a write request designating a PVOL (primary volume) 26A, that is, the remote copy is an asynchronous remote copy in which the write request is completed even if write target data accompanying the write request is not copied to a SVOL 26B (secondary volume). In the asynchronous remote copy, a JNL (journal) to be described later is used.

The primary storage system 200A has one or more volumes 26 (26A, 26JA, 26RA) and Pool (capacity pool) 26PA. The primary storage system 200A includes, for example, a primary storage PVOL 26A, a journal volume (JVOL) 26JA (primary journal volume) that stores a JNL related to data stored in the PVOL 26A, and a RootVOL 26RA (primary intermediary volume) that stores data of the PVOL 26A and the JVOL 26JA.

The secondary storage system 200B includes one or more volumes 26 (26B, 26JB, 26RB) and a Pool (capacity pool) 26PB. The secondary storage system 200B includes, for example, a JVOL 26JB (secondary journal volume) which is a transfer destination of the JNL stored in the JVOL 26JA, a SVOL 26B in which JNL data (journal data) in the JNL stored in the JVOL 26JB is stored, and a RootVOL 26RB (secondary intermediary volume) that stores data of the JVOL 26JB and the SVOL 26B.

These volumes 26 of the primary storage system 200A and the secondary storage system 200B are virtual volumes (VVOL). Data entity of the primary storage system 200A is stored in the Pool 26PA, and data entity of the secondary storage system 200B is stored in the Pool 26PB. The storage area of the Pool 26 (26PA, 26PB) is constituted by a substantial volume (RVOL).

The RootVOL 26RA is a volume intended to share the same data between the PVOL 26A and the JVOL 26JA, and it is not necessary to copy the same data between these volumes. Accordingly, the need for a cache memory to be consumed for copying data is eliminated, and the need for processing for copying data is eliminated, thereby improving processing efficiency. The RootVOL 26RB is a volume intended to share the same data between the SVOL 26B and the JVOL 26JB, and it is not necessary to copy the same data between these volumes. Accordingly, the need for a cache memory to be consumed for copying data is eliminated, and the need for processing for copying data is eliminated, thereby improving processing efficiency.

The PVOL 26A and the SVOL 26B constitute a VOL pair (copy pair). The remote copy of data stored in the PVOL 26A to the SVOL 26B is achieved via the JVOL 26JA and the JVOL 26JB. The storage area of any volume 26 may be based on the drive group, and at least a part of the JVOL 26J may be based on the memory 213 (for example, the cache memory area of the memory 213) in the controller 210. In at least one of the storage systems 200A and 200B, one JVOL 26J (26JA, 26JB) may be provided for a plurality of VOL pairs. A plurality of JVOLs 26J may be provided for one VOL pair. The number of JVOLs 26J may be different for one VOL pair between the storage systems 200A and 200B.

Although it has been described that the remote copy of data from the PVOL 26A to the SVOL 26B is performed via the JVOL 26J, in the present embodiment, the remote copy target data written to the PVOL 26A of the primary storage system 200A is stored in the RootVOL 26RA, and remote copy target data of the RootVOL 26RA is read from the JVOL 26JA and transmitted to the secondary storage system 200B. In the secondary storage system 200B, the remote copy target data written to the JVOL 26JB is stored in the RootVOL 26RB, and the remote copy target data of the RootVOL 26RB may be referred to from the SVOL 26B. Therefore, it is not necessary to copy data between the PVOL 26A and the JVOL 26JA and between the SVOL 26B and the JVOL 26JB.

Write target data 2520 is stored in the PVOL 26A or the SVOL 26B. Here, in the present embodiment, since the PVOL 26A and the SVOL 26B are virtual volumes, the entity of the write target data 2520 is stored in RVOL in the Pool 26P (26PA, 26PB) via the RootVOL 26R (26RA, 26RB).

The JVOLs 26J (26JA and 26JB) are volumes for storing the JNLs. The JNL includes JNL data 2524 and a JNCB (journal control block) 2523. The JNL data 2524 is the same as the write target data written to the PVOL 26A, and is also the same as the data copied to the SVOL 26B. In the present embodiment, since the JVOLs 26J (26JA and 26JB) are virtual volumes, the entity of the JNL data 2524 is stored in the RVOL in the Pool 26P (26PA and 26PB) via the RootVOLs 26R (26RA and 26RB). Therefore, the same data is managed in the same area of the RootVOL 26R without copying the data between the PVOL 26A and the JVOL 26JA and between the SVOL 26B and the JVOL 26JB.

The JNCB 2523 is an example of metadata of the JNL data 2524. Specifically, the JNCB 2523 includes information such as a logical storage destination address (for example, a logical block address (LBA)) in the JVOL of the JNL data 2524, an address (an address in the PVOL 26A) of a logical storage destination of the write target data that is a source of the JNL data 2524, an ID of the PVOL 26A in which the write target data that is a source is stored (and/or an ID of the SVOL 26B constituting a VOL pair with the PVOL 26A), and a sequence number (SEQ #: an order of write requests to which the original write target data is attached). As the order of the write requests, a time stamp may be used. Using the information of the JNCB 2523, the storage destination of the corresponding JNL data 2524 can be identified from the JNCB 2523 as indicated by arrows in FIG. 3.

The JVOL 26J (26JA, 26JB) has a JNCB area 2521 in which a plurality of JNCBs 2523 are stored, and a JNL data area 2522 in which a plurality of pieces of JNL data 2524 are stored. The storage area of the JNCB area 2521 is constituted by a substantial volume (RVOL). In the JNCB area 2521, the JNCBs 2523 are stored in the order of SEQ #.

The RootVOL 26R (26RA, 26RB) includes a mapping table storage area 2525 for storing a mapping table and a data area 2526 for storing the write target data. The mapping table storage area 2525 stores a PVOL/SVOL mapping table 2527 indicating a correspondence relationship between a storage address of data of the data volume (PVOL or SVOL) and a data storage address of the RootVOL 26R, and a JVOL mapping table 2528 indicating a correspondence relationship between a storage address of JNL data of the JVOL and a storage address of the RootVOL 26R. According to the PVOL/SVOL mapping table 2527, as indicated by the arrows in FIG. 3, the storage destination of data 2529 in the data area 2526 of the RootVOL can be identified from an entry corresponding to the storage address of the write target data 2520 of the PVOL or the SVOL. According to the JVOL mapping table 2528, as indicated by the arrows in FIG. 3, the storage destination of the data 2529 in the data area 2526 of the RootVOL can be identified from the entry corresponding to the storage address of the JNL data area 2522 of the JVOL. In the present embodiment, the same data 2529 in the data area 2526 of the RootVOL can be set to be referred to from the PVOL or SVOL and the JVOL. In the above example, the PVOL/SVOL mapping table 2527 and the JVOL mapping table 2528 are stored in the RootVOL 26R, and the respective tables may be stored in the PVOL, SVOL, and JVOL or may be stored in the management area 221 of the memory 213.

The PVOL 26A or the SVOL 26B is a volume accessed from the host 100, whereas the JVOL 26 is not a volume directly accessed from the host 100. Therefore, if the JNCB area 2521 and the JNL data area 2522 in the JVOL 26 are allocated in the RootVOL 26R, the JVOL 26 may be omitted. Alternatively, similarly, in a configuration without the JVOL 26, the JNCB 2523 and the JVOL mapping table 2528 may be integrated (the JNCB 2523 is arranged in the mapping table storage area 2525 instead of the JVOL mapping table 2528), and the JNCB 2523 may directly refer to the data 2529 of the data area 2526. By eliminating the JVOL 26 as described above, the number of components of the remote copy can be reduced, which contributes to reducing the number of operations and management tasks such as JVOL capacity management of a user.

The remote copy is executed, for example, as follows. That is, according to a write request from the primary host 100A, the primary storage system 200A stores the write target data in the storage area of the RootVOL 26RA (the cache area of the RootVOL 26RA or the storage area of the Pool 26PA) as processing for storing the write target data accompanying the write request in the PVOL 26A. The primary storage system 200A updates the PVOL mapping table 2527 so that the storage address of the RootVOL 26RA can be referred to from the PVOL 26A when the write target data is stored in the RootVOL 26RA.

Next, the primary storage system 200A stores, in the JVOL mapping table 2528, the storage address of the RootVOL 26RA of the write target data in the updated PVOL mapping table 2527 to make the write target data (corresponding to the JNL data) virtually copied to the JVOL 26JA, stores the JNCB 2523 corresponding to the JNL data in the JNCB area 2521 to complete the JNL, and reports write completion to the primary host 100A.

The primary storage system 200A transfers the JNL to be transferred to the secondary storage system 200B asynchronously with the processing performed in response to the write request. Here, the primary storage system 200A may transfer the JNL in response to a JNL read request from the secondary storage system 200B, or may voluntarily transfer the JNL without a JNL read request.

As processing of receiving the JNL and storing the received JNL in the JVOL 26JB, the secondary storage system 200B stores the JNL data in the storage area of the RootVOL 26RB (the cache area of the RootVOL 26RB or the storage area of the Pool 26PB), and stores the JNCB in the storage area of the RootVOL 26RB (the cache area of the RootVOL 26RB or the storage area of the Pool 26PB). The secondary storage system 200B updates the JVOL mapping table 2528 so that the storage address of the RootVOL 26RB can be referred to from the JVOL 26JB when the JNL data is stored in the RootVOL 26RB.

Next, the secondary storage system 200B stores, based on the JNCB in the JNL, the storage address of the RootVOL 26RA of the JNL data in the updated JVOL mapping table 2528 in the SVOL mapping table 2527, thereby virtually copying the JNL data in the SVOL. Accordingly, the remote copy from the PVOL 26A of the primary storage system 200A to the SVOL 26B of the secondary storage system 200B is executed.

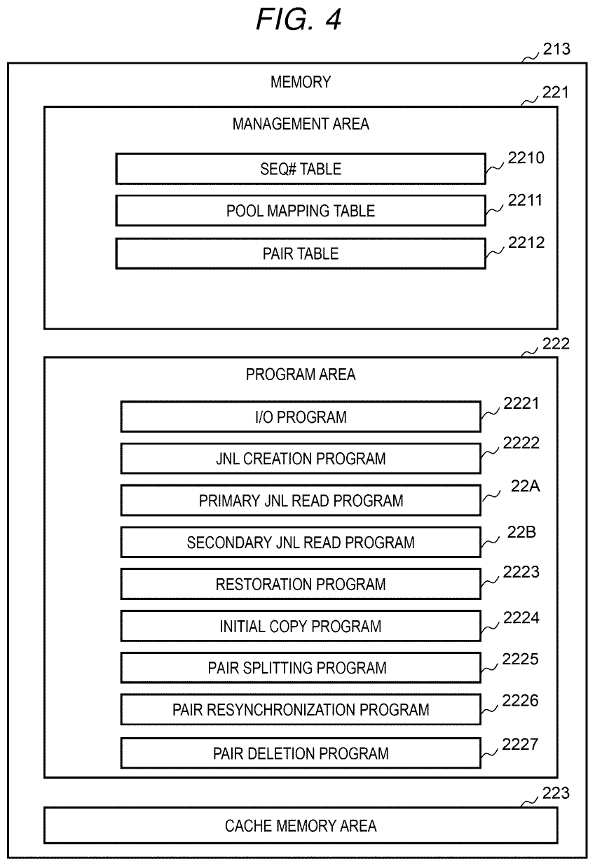

FIG. 4 is a configuration diagram of the memory of the storage system according to an embodiment.

The memory 213 includes a management area 221, a program area 222, and a cache memory area 223.

The management area 221 is an area for storing management information. In the present embodiment, the management area 221 stores, as the management information, a SEQ # table 2210, a pool mapping table 2211, and a pair table 2212. The SEQ # table 2210 and the pool mapping table 2211 will be described later. The pair table 2212 includes, for each VOL pair, an ID of the PVOL, an ID of the SVOL, and an ID of the storage system 200 that is a copy partner. The pair table 2212 may include a pair state indicating a state such as temporary suspension, normality, or abnormality of copy processing.

The program area 222 stores programs. In the present embodiment, the program area 222 stores, as the programs, an I/O program 2221, a JNL creation program 2222, a primary JNL read program 22A, a secondary JNL read program 22B, a restoration program 2223, an initial copy program 2224, a pair splitting program 2225, a pair resynchronization program 2226, and a pair deletion program 2227.

The I/O program 2221 is executed by the processor 212 to perform data I/O processing on the PVOL (or the SVOL) in response to an I/O request (write request, read request) from the host 100 (100A, 100B). The JNL creation program 2222 is executed by the processor 212 to perform processing of creating JNL data. The primary JNL read program 22A is executed by the processor 212 to perform processing of transferring a JNL. The secondary JNL read program 22B is executed by the processor 212 to perform processing of receiving the transferred JNL. The restoration program 2223 is executed by the processor 212 to perform processing of restoring data to an SVOL. The initial copy program 2224 is executed by the processor 212 to perform initial copy processing at the time of creating a pair of a PVOL and a SVOL. The pair splitting program 2225 is executed by the processor 212 to perform processing of stopping the remote copy. The pair resynchronization program 2226 is executed by the processor 212 to perform processing of resynchronization of the split pairs. The pair deletion program 2227 is executed by the processor 212 to perform processing of deleting a pair. In the present specification, since the programs 2224 to 2227 execute the same processing as that of the program in the related art, the description thereof will be omitted.

The cache memory area 223 is an area for temporarily storing data. The cache memory area 223 may have an area for temporarily storing data for each volume.

The storage system 200 having the memory 213 can function as either or both storage system of the primary storage system 200A and the secondary storage system 200B. For example, when the storage system 200 has the PVOL 26A and does not have the SVOL 26B, the storage system 200 functions as the primary storage system 200A. When the storage system 200 does not have the PVOL 26A but has the SVOL 26B, the storage system 200 functions as the secondary storage system 200B. When the storage system 200 has the SVOL 26B in a first VOL pair and the PVOL 26A in a second VOL pair, the storage system 200 functions as both the primary storage system 200A and the secondary storage system 200B. When the storage system 200 functions as one of the primary storage system 200A and the secondary storage system 200B, a part of programs unnecessary for the function may not be stored in the memory 213.

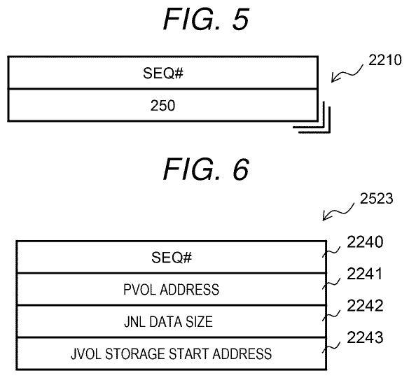

FIG. 5 is a configuration diagram of the SEQ # table according to an embodiment.

The SEQ # table 2210 for a copy source includes information indicating a SEQ # of the latest JNL, that is, the JNL created most recently. According to the information, it is possible to identify the SEQ # to be included in a JNL to be created next. For example, the SEQ # included in the JNL to be created next is a number next to the SEQ # represented by the current SEQ # table 2210, for example, a number incremented by 1. The SEQ # table 2210 for the copy source may include information indicating the SEQ # of the oldest JNL among the JNLs not yet transferred to the copy destination, that is, the JNL including the JNL data of the write target data with the oldest write reception time. According to the information, the JNL to be transferred next can be identified.

Meanwhile, the SEQ # table 2210 for the copy destination includes information indicating the SEQ # of the oldest JNL among the JNLs that are not reflected in the SVOL 26B. According to the information, it is possible to identify the SEQ # included in the JNL to be reflected next. The SEQ # table 2210 for the copy destination may include information indicating the SEQ # of the oldest JNL among the JNLs not yet received from the copy source. According to the information, a JNL to be requested to the primary storage system 200A next can be identified.

FIG. 6 is a configuration diagram of a JNCB according to an embodiment.

The JNCB 2523 includes information of a SEQ # 2240, a PVOL address 2241, a JNL data size 2242, and a JVOL storage start address 2243. The SEQ # 2240 represents a SEQ # allocated to a JNL including the JNCB 2523. The PVOL address 2241 indicates an address (for example, an ID of the PVOL 26A and an LBA indicating the area of the PVOL 26A) of the area of the PVOL 26A in which the JNL data (write target data) 2524 corresponding to the JNCB 2523 is stored. The JNL data size 2242 indicates a size of the JNL data 2524 corresponding to the JNCB 2523. The JVOL storage start address 2243 indicates a start address of an area in the JVOL 26J in which the JNL data 2524 corresponding to the JNCB 2523 is stored.

In addition, as described above, when there is no JVOL 26 and the JNCB 2523 and the JVOL mapping table 2528 are integrated, an address to be stored in the JVOL storage start address 2243 is not the start address of the area in JVOL 26J but a reference address of the data 2529 in the data area 2526 of the RootVOL 26.

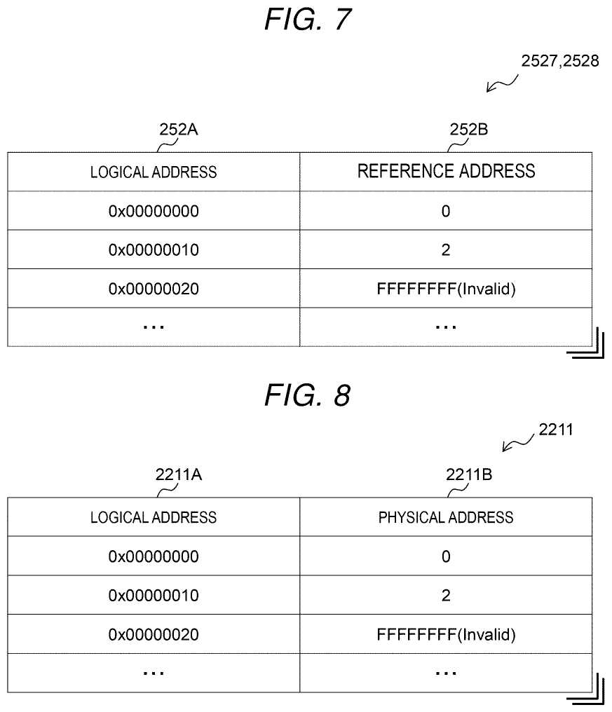

FIG. 7 is a configuration diagram of a volume mapping table according to an embodiment.

As the volume mapping table, there are the PVOL/SVOL mapping table 2527 and the JVOL mapping table 2528 (journal volume mapping table), but since the basic configurations of these mapping tables are the same, they will be described using the same drawing for convenience.

The volume mapping table (2527, 2528) is a table for managing a correspondence relationship between logical addresses of the volumes (the PVOL 26A, the SVOL 26B, the JVOL 26JA, the JVOL 26JB) in which data is stored and reference addresses which are addresses of other areas corresponding to the addresses. An entry of the volume mapping table (2527, 2528) includes fields of a logical address 252A and a reference address 252B.

In the logical address 252A, logical addresses of target volumes (the PVOL 26A, the SVOL 26B, the JVOL 26JA, and the JVOL 26JB) are stored. Each entry is arranged and stored in a page ascending order from a head address in the volume.

The reference address 252B stores an address at which data stored in the logical address of the volume corresponding to the entry is stored. In the present embodiment, since the data is stored in units of pages, the address stored in the reference address 252B is, for example, a page number. When a valid value such as “0” or “2” is stored in the reference address 252B, it means that the data is stored in the storage system that stores the volume mapping table. On the other hand, when an invalid value (Invalid) such as “FFFFFFFF” is stored in the reference address 252B, it means that valid data is not stored. In the present embodiment, the logical address of the RootVOL 26R (an address set in a logical address 2211A in FIG. 8: an intermediate logical address) is stored in the reference address 252B.

FIG. 8 is a configuration diagram of a pool mapping table according to an embodiment.

The pool mapping table 2211 is a table that manages a correspondence relationship between a logical address of a volume (the RootVOL 26R) in which data is stored and a physical address that is an address of a physical area corresponding to the address. The entry of the pool mapping table 2211 includes fields of the logical address 2211A and a physical address 2211B.

In the logical address 2211A, the logical address (intermediate logical address) of the RootVOL 26R is stored. The logical address of the logical address 2211A corresponds to an address of the reference address 252B of the volume mapping table. The physical address 2211B stores an address (a physical address of the RVOL) of the Pool 26P allocated to a logical address corresponding to the entry.

Next, a processing operation in the remote copy system 10 will be described.

First, write processing performed by the primary storage system 200A will be described.

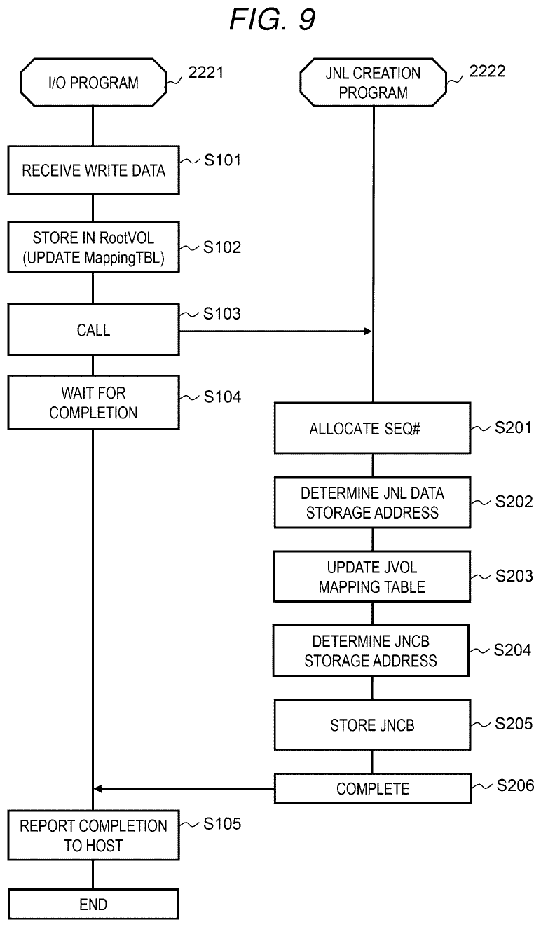

FIG. 9 is a flowchart showing the write processing according to an embodiment.

In the primary storage system 200A, when the I/O program 2221 (strictly speaking, the processor 212 that executes the I/O program 2221) receives a write request to the PVOL 26A from the primary host 100A (S101), the I/O program 2221 stores the write target data accompanying the received write request in the storage area (for example, the cache memory area 223) of the RootVOL 26RA, and updates the PVOL mapping table 2527 (S102). Specifically, the I/O program 2221 stores the logical address of the storage area of the RootVOL 26RA storing the write target data in the reference address 252B in the entry corresponding to the logical address of the PVOL 26A targeted by the write request of the PVOL mapping table 2527. Although the write target data is directly stored in the storage area of the RootVOL 26RA to reduce the amount of data stored in the cache memory area 223 of the PVOL 26A, the write target data may be temporarily stored in the cache memory area 223 of the PVOL 26A and then stored in the storage area of the RootVOL 26RA. The received write target data may be compressed, and the compressed write target data may be stored in the storage area (the cache memory area 223) of the RootVOL 26RA. In this case, in the following processing, the write target data may be read as compressed write target data.

Next, the I/O program 2221 calls the JNL creation program 2222 (S103), and waits for the completion of the JNL creation program 2222 (S104).

On the other hand, the called JNL creation program 2222 (strictly speaking, the processor 212 that executes the JNL creation program 2222) allocates a SEQ # to the JNL, that is, a SEQ # after incrementing the current latest SEQ # (S201).

Next, the JNL creation program 2222 determines a storage address (for example, the storage start address in the JVOL 26JA) of the JNL data corresponding to the write target data (S202), and copies the storage address stored in the reference address 252B of the PVOL mapping table 2527 in step S102, that is, the logical address of the storage area of the RootVOL 26RA in which the write target data is stored, to the reference address 252B of the entry corresponding to the determined storage start address of the JVOL mapping table 2528 (S203). Accordingly, it is possible to refer to the write target data (JNL data) stored in the RootVOL 26RA by accessing the JVOL 26JA without copying the write target data to the JVOL 26JA. In addition, since it is not necessary to actually copy the write target data to the JVOL 26JA, processing efficiency can be improved and a processing load can be reduced, and since a cache memory capacity required for actual copying is not used, the required cache memory capacity can be reduced. Therefore, even when the primary storage system 200A is implemented by a public cloud or the like and an amount of resources is limited, journal creation processing can be efficiently performed, and the resources of the primary storage system 200A can be used for processing other than remote copy.

Next, the JNL creation program 2222 determines the storage address for storing the JNCB corresponding to the JNL data (S204), creates the JNCB 2523 including the SEQ # allocated in step S201, and stores the JNCB 2523 in the storage area corresponding to the determined storage address (for example, the cache memory area 223 corresponding to the JVOL 26JA or the JNCB area 2521 in the Pool 26PA corresponding to the JVOL 26JA) (S205). The JNCB 2523 may be stored from the cache memory area 223 to the Pool 26PA after being stored in the cache memory area 223 corresponding to the JVOL 26JA.

Next, the JNL creation program 2222 notifies the I/O program 2221 of the completion of the processing (S206).

Upon receiving the completion notification from the JNL creation program 2222, the I/O program 2221 reports the write completion to the primary host 100A, which is a transmission source of the write request, without waiting for the write target data to be stored in the Pool 26PA (S105).

Here, according to the write processing, when a write request for the same area as an area written in the past of the PVOL 26A is received from the primary host 100A, the storage address where the latest write target data is stored is stored in the reference address 252B of the PVOL mapping table 2527, and the storage address where the latest write target data is stored is stored in the JVOL mapping table 2528. If the restoration of the write target data corresponding to the past write request is not set to the SVOL 26B, the storage address of the area in which the past write target data is stored is also stored in the JVOL mapping table 2528. As described above, when the write target data corresponding to the past write request is not restored to the SVOL 26B, the storage address of the area in which all the past write target data that is not restored is stored is stored in the JVOL mapping table 2528.

Next, JNL transfer processing for transferring a JNL from the primary storage system 200A to the secondary storage system 200B will be described.

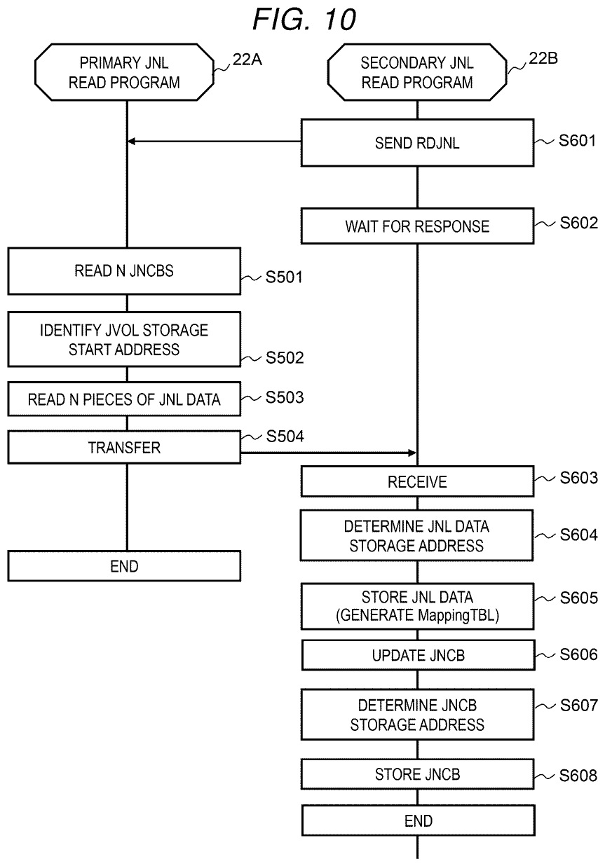

FIG. 10 is a flowchart showing the JNL transfer processing according to an embodiment.

The secondary JNL read program 22B of the secondary storage system 200B (strictly speaking, the processor 212 that executes the secondary JNL read program 22B) transmits a RDJNL (a journal read request), which is a read request for reading the JNL, to the primary storage system 200A (S601), and waits for a response from the primary storage system 200A (S602).

The primary JNL read program 22A of the primary storage system 200A (strictly speaking, the processor 212 that executes the primary JNL read program 22A) reads the non-transferred N JNCBs 2523 from the JVOL 26JA in response to the RDJNL received from the secondary storage system 200B (S501), and identifies the JVOL storage start address 2243 of each of the N JNCBs 2523 (S502).

Next, the primary JNL read program 22A reads the corresponding N JNL data from each of the identified N JVOL storage start addresses (S503), and transfers the N JNLs (JNL data and the corresponding JNCB 2523) to the secondary storage system 200B (S504). A read destination in step S503 is, for example, the cache memory area 223 of the RootVOL 26RA corresponding to the JVOL storage start address 2243. In step S504, the primary JNL read program 22A may compress and transfer the JNL. In this case, the size of the compressed JNL data may be stored in the JNCB 2523. The compression may be performed for each piece of JNL data, or N pieces of JNL data to be transferred may be collectively compressed. When the N pieces of JNL data are collectively compressed, the size of the compressed JNL data of the N pieces of JNL data may be stored in the JNCB 2523 corresponding to the oldest SEQ # transferred in the RDJNL.

The secondary JNL read program 22B of the secondary storage system 200B receives the N JNLs from the primary storage system 200A (S603). When the compressed JNL data is received, the secondary JNL read program 22B may decompress the JNL data.

Next, the secondary JNL read program 22B refers to the JNL data size 2242 and the like of the N JNCBs 2523, determines the storage destination address (for example, the JVOL storage start address) in which each piece of JNL data is stored (S604), stores the JNL data in the storage area (for example, the cache memory area 223) of the RootVOL 26RB, and updates the JVOL mapping table 2528 (S605). Specifically, the secondary JNL read program 22B stores the logical address of the storage area of the RootVOL 26RB in which the JNL data is stored in the reference address 252B in the entry corresponding to the determined JVOL storage start address of the JVOL 26JB in the JVOL mapping table 2528. Although the JNL data is directly stored in the storage area of the RootVOL 26RB to reduce an amount of data stored in the cache memory area 223 of the JVOL 26JB, the JNL data may be temporarily stored in the cache memory area 223 of the JVOL 26JB and then stored in the storage area of the RootVOL 26RB.

Next, the secondary JNL read program 22B updates the N JNCBs 2523 (S606). Specifically, the secondary JNL read program 22B sets the JVOL storage start address 2243 of JNCB 2523 to the logical address of the area in the JVOL 26JB.

Next, the secondary JNL read program 22B determines the storage address of each JNCB 2523 in the JVOL 26JB (S607), stores each JNCB 2523 in the area corresponding to the determined storage address (for example, the cache memory area 223 corresponding to the JVOL 26JB or the JNCB area 2521 in the Pool 26PB corresponding to the JVOL 26JB) (S608), and ends the processing.

Next, restoration processing of reflecting the JNL data of the JVOL 26JB in the SVOL 26B will be described.

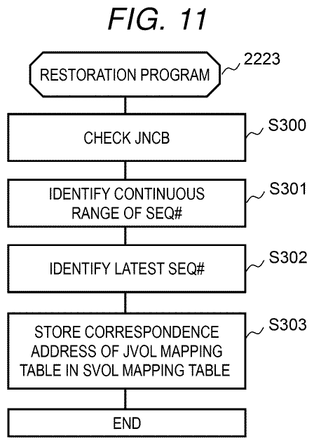

FIG. 11 is a flowchart showing the restoration processing according to an embodiment.

In the secondary storage system 200B, the restoration program 2223 (strictly speaking, the processor 212 that executes the restoration program 2223) checks the JNCB stored in the JVOL 26JB (S300), identifies a range in which the SEQ # continues from the oldest SEQ # among the JNLs that are not reflected in the SVOL 26B (S301), and identifies the latest SEQ # in the identified range (S302).

Next, the restoration program 2223 reflects the JNL data that is not reflected in the SVOL 26B in order from the oldest SEQ # to the latest SEQ # in a continuous range of the identified SEQ # in the SVOL 26B (S303). Specifically, the restoration program 2223 does not read the entity of the JNL data to the cache memory area 223, and copies the storage address of the reference address 252B in the entry corresponding to the JNL in the JVOL mapping table 2528, that is, the entry corresponding to the JVOL storage start address 2243 of the JNCB 2523 of the SEQ # scheduled to be reflected in the SVOL 26B to the reference address 252B of the entry corresponding to the PVOL address 2241 of the JNCB 2523 in the SVOL mapping table 2527. Accordingly, it is possible to refer to the JNL data (that is, write target data) stored in the RootVOL 26RB by accessing the SVOL 26B without actually copying the JVOL data to the SVOL 26B. Since it is not necessary to actually copy the JVOL data to the SVOL 26B, the processing efficiency can be improved and the processing load can be reduced, and since the cache memory area required when actually copying is not required, the required capacity of the cache memory area can be reduced. Therefore, even when the secondary storage system 200B is implemented by a public cloud or the like and the amount of resources is limited, the restoration processing can be efficiently performed, and the resources of the secondary storage system 200B can be used for processing other than the remote copy.

The restoration processing may be executed in parallel by a plurality of jobs. In this case, regarding the processing in which the same address of the SVOL 26B is set as the restoration destination, the same job may be processed in order from the oldest SEQ #, and by doing so, even if the processing is not performed in order of the SEQ # among the plurality of jobs, it is possible to avoid a so-called reversion, in which JNL data with a newer SEQ # is rewritten by JNL data with an older SEQ #.

Next, read processing of reading data from the PVOL 26A of the storage system 200A will be described.

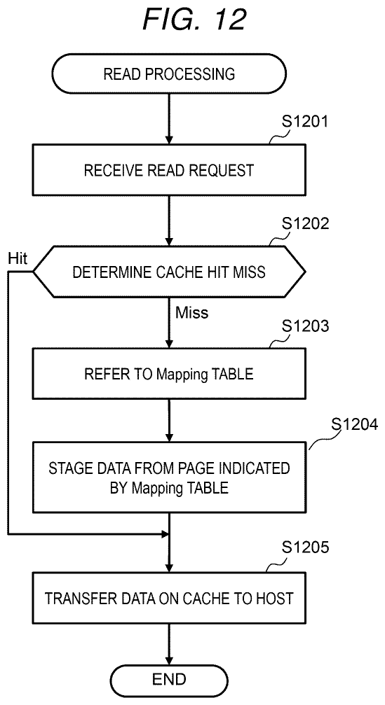

FIG. 12 is a flowchart showing the read processing according to an embodiment.

The I/O program 2221 of the primary storage system 200A (strictly speaking, the processor 212 that executes the I/O program 2221) receives a read request requesting reading of data from the PVOL 26A of the primary storage system 200A from the primary host 100A (S1201). The read request includes a storage area (read target area) of the read target data in the PVOL 26A.

Next, the I/O program 2221 performs cache hit miss determination for determining whether the read target data is stored in the cache memory area 223 corresponding to the PVOL 26A (S1202). In step S1202, it may be determined whether not only the cache memory area 223 corresponding to the PVOL 26A but also the cache memory area 223 corresponding to the RootVOL 26RA is stored. In this way, a cache hit rate of the read target data can be improved.

As a result of the cache hit miss determination, when the read target data is stored in the cache memory area 223, that is, when a cache hit occurs (S1202: Hit), the I/O program 2221 transfers cache hit data to the primary host 100A (S1205), and ends the read processing.

On the other hand, when the read target data is not stored in the cache memory area 223, that is, when a cache miss occurs (S1202: Miss), the I/O program 2221 refers to the PVOL mapping table 2527, identifies an entry corresponding to the logical address of the read target area in the PVOL 26A, identifies a reference address in the RootVOL 26RA from the identified entry, identifies an entry corresponding to the identified reference address in the pool mapping table 2211, and identifies a physical address (for example, a page) corresponding to the reference address in the RootVOL 26RA from the identified entry (S1203).

Next, the I/O program 2221 stages the read target data from the identified physical address (S1204). A staging destination may be a cache memory area corresponding to the PVOL 26A or a cache memory area corresponding to the RootVOL 26RA.

After the processing of step S1204, the I/O program 2221 transfers the staged read target data to the primary host 100A (S1205), and ends the read processing.

In the present embodiment, the “remote copy processing” is processing until data written in the PVOL 26A is reflected in the SVOL 26B as JNL data via the JVOL 26JA and the JVOL 26JB. The remote copy processing includes the JNL transfer processing and the restoration processing. The “JNL transfer processing” is processing from when the processing for transferring the JNL is started until the storage of the transferred JNL in the secondary storage system 200B is completed, and in the present embodiment, is processing from when the secondary storage system 200B starts sending an RDJNL until the JNL included in the response to the RDJNL (response from the primary storage system 200A) is stored in the secondary storage system 200B. The “restoration processing” is processing that enables the SVOL 26B to refer to the JNL data in the secondary storage system 200B.

The invention is not limited to the above-described embodiment, and can be appropriately modified and implemented without departing from the gist of the invention.

For example, in the JNL transfer processing of the above embodiment, the JNL is transferred from the primary storage system 200A in response to the RDJNL from the secondary storage system 200B, and the secondary storage system 200B stores the JNL. The primary storage system 200A may transmit the WRJNL (the JNL write request) to the secondary storage system 200B, and the secondary storage system 200B may store, in response to the WRJNL, data (a plurality of JNCBs and at least a part of a plurality of pieces of JNL data) associated with the WRJNL.

In the above embodiment, the JNCB 2523 is stored in the JNCB area 2521 of the JVOL 26, and the invention is not limited thereto, and for example, the information of the JNCB 2523 may be stored and transferred as a parameter of a command of the WRJNL or the RDJNL.

In the above embodiment, as shown in the mapping tables of FIGS. 7 and 8, data is managed in units of pages. For example, when the write target data is not subjected to page alignment, that is, has a size smaller than the page, or when the size of the write target data is equal to or larger than the page size but is not a multiple of the page size and has some parts smaller than the page size, it is necessary to read data in a range other than a write target range in the page area, merge the data with the write target data, and adjust the data to the page size in order to enable management in units of pages. The processing requires reading of stored data at the time of write processing, which greatly affects write performance. In order to avoid this, for example, when the write target data is not subjected to the page alignment, the JNL creation program 2222 may execute the processing of step S102 of FIG. 9 only for an area that can be processed in units of pages, skip the processing of step S102 for a part that does not satisfy the page size, and create JNL data by copying the write target data as the JNL data on the cache memory area 223 as in the related art, instead of the processing of step S203.

In addition, in the secondary storage system 200B, there is a case in which the received JNL data has a size smaller than the page, and the restoration program 2223 may perform the restoration processing by copying the JNL data to the SVOL on the cache memory area 223 as in the related art.

The JNL transfer processing of FIG. 10 may be used in initial copy for matching the data of the PVOL 26A and the SVOL 26B at the time of creating the pair of the PVOL 26A and the SVOL 26B. For example, the initial copy program 2224 of the primary storage system 200A and the secondary storage system 200B performs the initial copy from the PVOL 26A to the SVOL 26B. At this time, if the JNL transfer processing of FIG. 10 is used, it is necessary to make it possible for the JVOL 26JA to refer to all the stored data of the PVOL 26A of an initial copy target. On the other hand, after receiving the RDJNL, that is, before step S501, the primary JNL read program 22A may refer to the stored data of the PVOL 26A from the JVOL 26JA in an ascending order of the logical addresses. That is, the same processing as steps S202 to S205 in the JNL creation processing may be performed on the stored data of the PVOL 26A.

What is claimed is:

1. A storage system comprising:
a secondary volume that is a copy destination of a primary volume in another storage system having the primary volume, wherein
a processor of the storage system
receives a journal including journal data that is write target data for the primary volume from the another storage system and metadata for the journal data,
associates a logical address of a secondary journal volume that manages the journal data included in the journal with a predetermined area of a capacity pool in the storage system, and
associates an address of the predetermined area associated with the journal data of the capacity pool with a logical address of the secondary volume in which the write target data indicated by the metadata included in the journal is stored.

2. The storage system according to claim 1, wherein
the processor of the storage system
associates the logical address of the secondary journal volume that manages the journal data included in the journal with an intermediate logical address associated with the predetermined area of the capacity pool in the storage system, and
associates the intermediate logical address with the logical address of the secondary volume in which the write target data indicated by the metadata included in the journal is stored.

3. The storage system according to claim 2, further comprising:
a secondary intermediary volume that stores a volume mapping table that stores a correspondence relationship between the logical address of the secondary volume and the intermediate logical address, and a journal volume mapping table that stores a correspondence relationship between the logical address of the secondary journal volume and the intermediate logical address.

4. The storage system according to claim 1, wherein
the processor of the storage system receives the journal in a compressed form from the another storage system and decompresses the compressed journal.

5. A storage system comprising:
a primary volume, wherein
a processor of the storage system
stores write target data for the primary volume in association with a predetermined area of a capacity pool in the storage system, and
creates metadata in a journal corresponding to writing of the write target data for the primary volume and stores the metadata in a journal volume, and associates the predetermined area of the capacity pool with a logical address in the journal volume that manages journal data in the journal.

6. The storage system according to claim 5, wherein
the processor of the storage system
associates a logical address in the primary volume of the write target data for the primary volume with an intermediate logical address associated with the predetermined area of the capacity pool in the storage system, and
associates the intermediate logical address associated with the predetermined area of the capacity pool with a logical address of a primary journal volume that manages the journal data included in the journal.

7. The storage system according to claim 6, further comprising:
a primary intermediary volume that stores a volume mapping table that stores a correspondence relationship between the logical address of the primary volume and the intermediate logical address, and a journal volume mapping table that stores a correspondence relationship between the logical address of the primary journal volume and the intermediate logical address.

8. The storage system according to claim 5, wherein
the processor of the storage system compresses the write target data and stores the compressed write target data in association with the predetermined area of the capacity pool.

9. The storage system according to claim 5, wherein
the processor of the storage system compresses one or more of the journals and transmits the compressed one or more journals to another storage system.

10. A remote copy method executed by a secondary storage system including a secondary volume that is a copy destination of a primary volume in a primary storage system having the primary volume, the method comprising:
the secondary storage system
receiving a journal including journal data that is write target data for the primary volume from the primary storage system and metadata for the journal data;
associating a logical address of a secondary journal volume that manages the journal data included in the journal with a predetermined area of a capacity pool in the secondary storage system; and
associating an address of the predetermined area associated with the journal data of the capacity pool with a logical address of the secondary volume in which the write target data indicated by the metadata included in the journal is stored.
